(19) United States
(12) Patent Application Publication
(10) Pub. No.: US 2024/0426552 A1
(43) Pub. Date: Dec. 26, 2024

(54) CLAY CALCINING PLANT

(71) Applicant: LOESCHE GMBH, Dusseldorf (DE)

(72) Inventors: Holger WULFERT, Dusseldorf (DE); Martin REFORMAT, Duesseldorf (DE); David LINDL, Nurnberg (DE); Ralf FINK, Nurnbert (DE)

(73) Assignee: LOESCHE GMBH, Dusseldorf (DE)

(21) Appl. No.: 18/690,128

(22) PCT Filed: Sep. 8, 2021
(86) PCT No.: PCT/EP2021/074725

§ 371 Date: Mar. 7, 2024

(51) Int. Cl. F27B 7/36; C04B 7/12; C04B 7/43; C04B 7/44; C04B 7/47

(52) U.S. Cl. CPC F27B 7/362; C04B 7/12; C04B 7/434; C04B 7/44; C04B 7/47; F27B 2007/365

(57) ABSTRACT

The invention relates to a clay calcination plant for activating clay as feed material, which has a proportion of at least 40% of thermally activatable layered silicates. The plant comprises a rotary kiln with a kiln inlet and a kiln outlet, wherein feed material is thermally treated while being conveyed through the rotary kiln. In addition, a gas infeed is provided at the kiln outlet and a gas outfeed at the kiln inlet. Furthermore, the clay calcination plant has a mixing chamber for generating a temperature-homogeneous flow of calcination gas, with a burner for generating flue gas and a process gas infeed for the infeed of warm process gas being provided.

The invention relates to a clay calcination plant for the activation of clay as a feed material. This clay has a significant proportion of at least 40%, preferably at least 50%, of thermally activatable layered silicates. These can be present, for example, in the form of kaolinite, illite and/or montmorillonite. The clay calcination plant has a directly heated rotary kiln, which has a kiln inlet and a kiln outlet. The rotary kiln is configured in such a way that the feed material is conveyed as a material flow from the kiln inlet to the kiln outlet. During this conveying process, the feed material is thermally treated, i.e. in particular heated to temperatures above room temperature.

Furthermore, a gas infeed is provided at the kiln outlet and a gas outfeed at the kiln inlet. The clay calcination plant is configured in such a way that calcination gas is guided from the gas infeed through the rotary kiln to the gas outfeed. In other words, the clay calcination plant has a rotary kiln which, like known rotary kilns, is operated in countercurrent, with the calcination gas serving to heat the feed material.

One of the world's largest producers of CO₂ is the cement industry. CO₂ is produced during the burning of clinker. The production of 1 ton of cement produces around 600 kg of CO₂. The production of around 6 billion tons of cement is forecast for 2050.

Various composite materials are possible and are already being used to replace clinker in cement, the production of which generates the most CO₂.

Of all the theoretically possible reactive materials, only fly ash (approx. 700 million tons per year worldwide) and granulated slag (approx. 300 million tons per year worldwide) are currently available in relevant quantities. The available quantities of both materials are subject to considerable cyclical and seasonal fluctuations. Furthermore, it is already predictable that both materials will no longer be available in the current quantity and quality in the future.

The amount of fly ash will decrease significantly with the increasing use of alternative energies, especially in Germany. The remaining amount will no longer be fully usable due to changes in the technological process, such as the lowering of boiler temperatures and thus a lower glass content, as well as the binding of mercury through additional activated carbon.

The quantities of ground granulated blast-furnace slag will also tend to decrease due to the growing use of scrap in steel production. Other possible reactive materials such as silica fume, natural pozzolans or, in Asia, rice husk ash play at best a locally limited role in reducing the proportion of clinker in cements, with annual quantities of well under 50 million tons per year.

Natural limestone is available in almost unlimited quantities. However, due to its largely inert properties, the quantity that can be used as a clinker substitute is very limited.

Calcined clays are another composite material. These are converted into pozzolans or materials with pozzolanic properties during tempering or calcination, which is used as an alternative in this description.

The use of kaolinite-rich clays, which are used as metakaolin either as a substitute for silica fume in high-performance concretes or as an aluminosiliceous component in geopolymers, is known to date. However, in order to use calcined clays as the main component in cement in the future, it will also be necessary to use more heavily contaminated clays that contain not only kaolinite but also montmorillonite or even illite as the main clay mineral. Such contaminated clays are very common and, unlike with clays rich in kaolinite, the cement industry would not have to enter into cost-intensive competition with other industries such as the paper industry or the ceramics industry.

In the context of the invention, calcination or tempering can be defined as a thermal treatment of over 400° C. When calcining clay, several of the following reactions generally occur: Splitting off of bound water or other gaseous substances, phase transformation, amorphization, recrystallization of amorphous and poorly crystallized phases as well as grain growth and sintering, the latter being undesirable for the production of a composite material for cement.

Similarly, recrystallization processes should be avoided, as these would destroy the binding and consolidation potential of the activated treated clay.

Pure dehydration of the clay usually takes place in the range between 150° C. and 250° C., depending on the exact composition. The maximum release of water of crystallization is around 565° C. A further transformation into so-called metaclays, as activated clays are called, takes place in the range of 600° C. to 900° C.

Above this temperature range, the other processes described above occur, which are undesirable in clay calcination, i.e. the activation of clay.

It is therefore essential not to exceed a temperature limit range of around 900° C. during clay calcination. For a realistic average clay composition, the optimum activation temperature is between 600° C. and 800° C. In conventional, directly heated rotary kilns, which have a long open flame in the rotary kiln with a temperature of approx. 1700° C., it is very easy to exceed this range, as it is hardly possible to influence the exact temperature profile, in particular its distribution. Often there is also a very uneven temperature distribution.

Therefore, the object underlying the invention is to create a clay calcination plant which has a directly heated rotary kiln that enables efficient activation of the clay.

According to the invention, this object is achieved by a clay calcination plant with features of claim 1.

Advantageous embodiments of the invention are indicated in the sub-claims, the description and the Figures and their explanations.

The clay calcination plant according to the invention is further configured in such a way that the gas infeed of the rotary kiln is fluidically connected to a mixing chamber for generating a temperature-homogeneous or isothermal flow of calcination gas. This pre-mixing chamber can have a cylindrical shape. In principle, the shape could also be designed differently. A burner for generating hot flue gas from combustion gas as an energy source and combustion air is provided at the face side of the mixing chamber.

The mixing chamber also has a process gas infeed to supply warm process gas. For this purpose, corresponding devices, such as feed lines, can be provided via which warm process gas from upstream, other processes can enter the mixing chamber via the process gas infeed. Furthermore, the process gas infeed, the burner and the mixing chamber are configured in such a way that, at least in the area of the process gas infeed, a spiral-like flow of the warm process gas is generated around the hot flue gas flowing axially into the mixing chamber by means of the burner. This allows the temperature-homogeneous flow of calcination gas to be generated.

The idea underlying the invention is to depart from a classic direct firing of a rotary kiln. According to the invention, the calcination gas, i.e. the hot gas with a temperature preferably in the range between 700° C. and 950° C., in particular in the range between 600° C. and 850° C., is generated in a device upstream of the rotary kiln. According to the invention, a special mixing chamber is provided for this purpose, which on the one hand has a burner which itself generates a proportion of the calcination gas by burning combustion gas with combustion air to generate flue gas. On the other hand, a process gas infeed is provided via which warm process gas can be guided into the mixing chamber.

However, this is still not sufficient to generate the desired temperature-homogeneous flow of calcination gas. This also requires extremely good mixing of the warm process gas with the flue gas from the burners. According to the invention, it is suggested that the process gas be blown or flowed into the mixing chamber in such a way that it spirally wraps around the flue gas of the burner in a flow, which is preferably introduced axially. This creates strong turbulence, which in turn achieves a high degree of mixing. Furthermore, differently configured mixing chambers and/or mixing chamber installations can also be provided, as long as a temperature-homogeneous flow of calcination gas is generated.

In principle, the burner and the process feed in the mixing chamber can be of any design as long as the spiral-like flow is generated. In one configuration, the burner can have a burner lance with a corresponding burner nozzle, which extends from the face side of the mixing chamber into the mixing chamber. The hot flue gas thus flows into the mixing chamber at the end of the burner lance. The burner can preferably be arranged axially and substantially on an axis of rotation of the mixing chamber, i.e. centrally in the mixing chamber. Furthermore, the process gas infeed can be provided farther away from the face side than the outlet of the hot flue gas at the burner lance. According to the invention, this enables even better mixing, so that the mixing chamber can also be designed shorter under certain circumstances.

In order to improve the mixing even further, baffle plates and/or baffle disks can be provided, particularly in the area where the process gas enters the mixing chamber through the process gas infeed or in the area where the gas exits the mixing chamber. These can also be referred to as whirling disks or remixing disks.

It is preferable if a process gas generator is provided, which is configured to heat calcination gas originating from the gas outfeed by means of a process gas burner, and if a mixing chamber pipe is provided to supply the heated process gas as warm process gas to the process gas infeed of the mixing chamber. Providing a second burner to generate a second gas flow for the mixing chamber has the advantage that a larger control range and better, simpler control of the outlet temperatures at the mixing chamber is possible. The fact that calcination gas that has already been guided through the rotary kiln once can be reheated in the process gas burner and reused means that external air, for example, does not have to be reheated to its maximum temperature.

A further advantage of reusing the calcination gas is that the hydrocarbon compounds in it can be decomposed and thus rendered harmless. This rendering harmless is necessary because, as described later, some of the calcination gases are inevitably also released into the environment in a further process step and the corresponding environmental regulations must therefore be complied with.

In addition, a thermal afterburning device with a thermal afterburner can be provided. For this purpose, an afterburning branch is provided in the mixing chamber pipe from the process gas generator to the mixing chamber. Part of the warm process gas is branched-off from the mixing chamber pipe and fed to the thermal afterburning device. This can preferably be a ratio of 60:40, wherein 60% of the warm process gas is fed to the mixing chamber. The thermal afterburning device is configured to heat the supplied warm process gas by means of the thermal afterburner in such a way that any environmentally harmful substances still present in the resulting flue gas are burned-off or decomposed. The afterburning device is operated at a significantly higher temperature and/or a higher oxygen content than the process gas generator, so that any harmful components still present in the warm process gas are completely decomposed and toxic compounds are essentially no longer present. The split-up into the process gas generator and the thermal afterburning device ensures that the warm process gas, which is guided into the mixing chambers, does not have excessively high temperatures and can therefore be used more effectively in the subsequent process without any additional influence.

In order to further increase the energy efficiency of the clay calcination plant, a dryer, for example a drum dryer, can be arranged upstream of the kiln inlet of the rotary kiln, wherein the feed material to be fed into the rotary kiln via the kiln inlet is transported through the dryer and the calcination gas from the gas outfeed is guided through the dryer. In this way, the feed material, which is fed into the rotary kiln via the kiln inlet, can already be preheated and thus surface water can evaporate, for example.

Another way to improve the energy efficiency of the clay calcination plant is to arrange a pre-drying device for the feed material spatially above the rotary kiln, which device is configured and set up to preheat or pre-dry the feed material by means of radiant heat radiated from the rotary kiln and/or free convection of the rotary kiln and to supply it to the rotary kiln and/or the dryer.

The pre-drying device can, for example, be configured as an enclosed steel plate conveyor above the rotary kiln. This allows the radiant heat from the rotary kiln to heat the steel plate conveyor. In a similar way, warm gases flowing around the rotary kiln and heated by it can also enter the enclosure, be collected there and thus already pre-heat the feed material and vaporize surface water and the like.

It is also preferable if a control and regulation device is provided which adjusts the temperature of the calcination gas at the gas infeed for activating the feed material, at least by means of the burner in the mixing chamber and the quantity and/or temperature of the warm process gas.

As already explained, it is essential that the feed material, i.e. the clay to be activated, is heated to a maximum temperature of around 900° C. For this purpose, it is essential to ensure that-as explained-the temperatures are not too high, but also not too low. For this reason, the temperature of the calcination gas is adjusted accordingly via the control and regulation device. On the one hand, the burner in the mixing chamber is used for this, which can generate a different amount of flue gas and also different temperatures of the flue gas by means of its combustion gas and combustion air. Similarly, the quantity and/or temperature of the warm process gas originate from the process gas generator can also be adjusted. On the one hand, the process gas burner can be controlled accordingly. On the other hand, it is also possible to influence the amount of warm process gas guided into the measuring chamber. Overall, the control and regulation device thus ensures that in each case the optimum temperature is present at the gas infeed into the rotary kiln.

Additionally or alternatively, a further control and regulation device can be provided, which adjusts the oxygen content of the calcination gas at the gas infeed to influence the color of the activated feed material, at least by means of the burner in the mixing chamber and the quantity and/or oxygen content of the warm process gas. The control and regulation device can also be a combined control and regulation device with the control and regulation device described above. The oxygen content, i.e. whether the calcination gas produces a reductive or oxidative atmosphere, can be set using the control and regulation device described here. This is done, for example, by adjusting the proportion of combustion air, both for the burner in the mixing chamber and for the process gas burner. In other words, the lambda value can be set accordingly. The oxygen content can be further influenced via the ratio of flue gas to warm process gas. In addition to this, the hydrocarbons that escape from the clay can also be taken into account when setting the required atmosphere in the process gas generator.

Fe₂O₃ is present in the feed material. This can be converted to Fe₃O₄ in a reductive atmosphere and then to FeO. Fe₂O₃ has a red to yellow coloration. This is undesirable in the building materials industry. In contrast, Fe₃O₄ and FeO do not exhibit this red to yellow coloration. Based on the adjustment of the oxygen content of the calcination gas, the color of the calcined clay, i.e. the activated feed material, can be adjusted, which is then supplied to the cement industry.

A cooler, in particular a grate cooler, is provided downstream of the material flow of activated feed material from the kiln outlet of the rotary kiln. Said cooler is configured to cool hot, activated feed material to a temperature below 400° C. within ten to twenty minutes by means of cooling air. Preferably, the activated feed material has a temperature of around 100° C. at the end of the cooler.

The cooler is used to ensure that the calcined clay is cooled down quickly enough to prevent any further reaction, so that the iron reduction for color adjustment described above does not reverse. Experience has shown that this is no longer the case at temperatures below 400° C. The final temperature of the cooler is determined by the downstream process units, which can ideally process the activated feed material further at a temperature in the range of 100° C.

One option for such a unit is a comminution device provided downstream of the material flow after the cooler, in particular a vertical roller mill. Said device is configured to comminute the cooled and activated feed material to a maximum size of R60 μm<15%. This means that with a screen with a mesh size of 60 μm, a maximum of 15% of the material to be screened remains in the screen. In other words, 85% of the comminuted material has a diameter smaller than 60 μm.

It has been found that activated clay with such a fineness has particularly good pozzolanic properties and can therefore be used very well as an additive or composite material for the cement industry. At this point, it is also already possible to comminute clinker materials and other cement components simultaneously with the comminution device in addition to the activated clay and thus, in particular when using a vertical roller mill, to mix the different materials homogeneously. This eliminates the need for a subsequent separate mixing process. The activated clay can also be temporarily stored in a silo for this purpose. Further silos can also be present, for example to provide cement clinker and/or other materials and feed them into the vertical roller mill in a desired ratio.

It is advantageous if a dedusting device is provided, which is set up and connected for dedusting calcination gas from the dryer and/or the rotary kiln, and a first return line is provided in order to supply the dust separated in the first dedusting device from the calcination gas to a material flow of activated feed material upstream of the cooler and downstream of the rotary kiln. The dust absorbed and further conveyed by the calcination gas is primarily generated during the thermal comminution of the clay by the expulsion of crystal water and the resulting swelling of the clay. In addition, dust is created by the abrasion effect caused by the material movement in the rotary kiln.

Since the exact condition of the dust separated in the dedusting device, which can be configured as a cyclone, for example, is not known with regard to its degree of calcination, the dust is added to the material flow of hot feed material after the rotary kiln, since the temperature present there is sufficient to also calcine the very fine dust, if necessary. Therefore, this feed takes place before the material flow enters the cooler, preferably even at a distance from the cooler, so that the travel distance to the cooler is sufficient for the calcination of the dust to be carried out.

Furthermore, a second dedusting device can be provided, which is set up and connected for dedusting cooling air from the cooler, as well as a second return line on order to supply the dust separated in the second dedusting device from the cooling air to a material flow of cooled, activated feed material downstream of the cooler.

In a similar way to the rotary kiln, dust is also produced during cooling, especially on a grate cooler, which is entrained by the cooling air. This is already calcined feed material so that this material can be fed into the material flow downstream of the cooler.

By providing corresponding dedusting equipment, the carrier or process gases used are essentially not dust-laden, so that less energy has to be used to transport them and less wear occurs in the corresponding gas lines.

In order to make additionally the entire process more energy-efficient, the clay calcination plant can have a heat exchanger, which is set up to preheat combustion air for the process gas burner, for the thermal afterburner and/or the burner in the mixing chamber. This can be effected using the heat of the flue gas from the thermal afterburning device. As already described, the thermal afterburning device is used additionally to further heat some of the warm process gas from the process gas generator in order to decompose any environmentally harmful substances that may still be present, such as hydrocarbons. The heat exchanger is provided so that the energy content of this gas, which could in principle be released to the environment without any problems, is not wasted. By preheating the combustion air and using it in the existing burners, combustion gas can be saved as an energy source, as less additional energy is required to reach a desired temperature.

Another way to operate the clay calcination plant more energy-efficiently is to provide at least one power generator that generates electricity using the warm cooling air from the cooler and/or the flue gas from the thermal afterburning device. The flue gas could also have been guided through the heat exchanger described already above. Both the cooling air from the cooler and the flue gas from the thermal afterburning device, which was passed through the heat exchanger, still have a significantly higher temperature than the ambient temperature. This energy can be used to generate electricity, which can either be fed into the grid or used further in the clay calcination plant.

Advantageously, a conduit routing is provided to use flue gas from the thermal afterburning device and/or cooling air from the cooler as process gas for the comminution device. This can also be appropriately cooled flue gas or cooling air that has already been guided via power generators and/or heat exchangers. The comminution device, for example a vertical roller mill, requires process gases with a temperature in the range of 95° C. To avoid having to generate this temperature separately with a heating gas generator and thus to eliminate the need for additional energy, flue gas that is still warm or the heated cooling air from the cooler can be used.

In principle, however, there is no reason why a hot gas generator should not also be provided in order to have greater flexibility in the use of the comminution device.

Furthermore, a conduit routing can be provided to supply calcination gas that has been at least partially cleaned of dust from the first dedusting device to the process gas generator and/or to supply the cooling air that has been at least partially cleaned of dust from the second dedusting device to the comminution device as process gas.

By continuing to use dedusted calcination gas or dedusted cooling air, the additional heating of the calcination gas or the process air for the comminution device can be minimized. As dedusted gas/air is used, less energy is required for pneumatic conveying.

In order to clean the already dedusted process air or gases of the entire clay calcination plant of fine particles, it may be necessary to provide a corresponding filter device downstream the comminution device, which carries out the final dedusting of the gases before they are either reintroduced into the clay calcination plant or disposed of via a stack. Due to the described coupling of the individual process stages, in accordance with the intended conduit routing, there is only one point of residual dedusting of the process gases. Intermediate cleaning is therefore not necessary.

The invention is explained below by means of a schematic exemplary embodiment with reference to the Figures. The Figures show in:

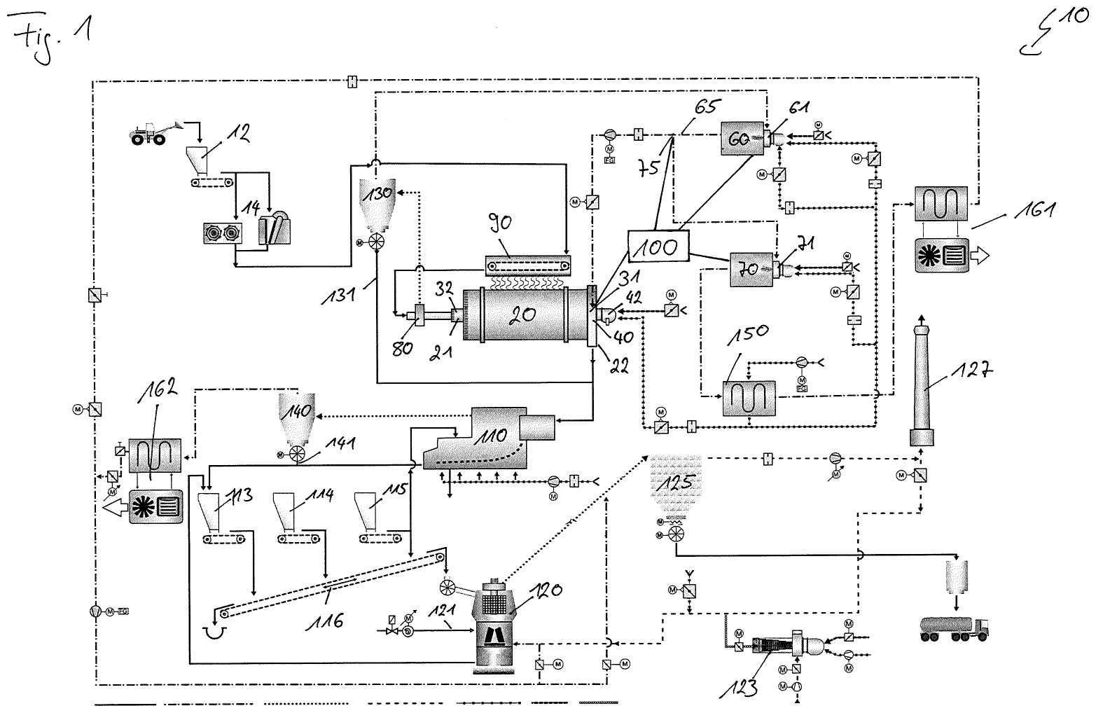

FIG. 1 a highly schematized and simplified structure of a clay calcination plant according to the invention; and

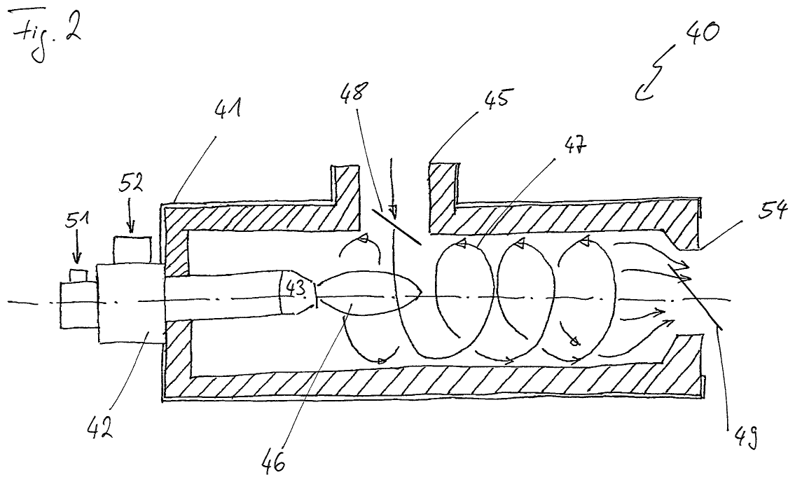

FIG. 2 a diagram of a mixing chamber according to the invention.

With reference to FIG. 1, the basic structure and function of a clay calcination plant 10 according to the invention will now be explained in greater detail.

First, following the material flow of the clay to be calcined in the clay calcination plant 10, the units through which the material flow passes are explained in greater detail. The existing process gas flows and a central control and regulation device 100 are then explained. It should be considered that in this case, the term process gas can refer to any gas used herein, wherein various gas flows are distinguished in greater detail below.

First, the clay to be activated and having a moisture content of 5% to 30% is fed into a feed bunker 12. It is drawn off from said bunker and fed to coarse crushing units 14. Different comminution units can be used depending on the moisture of the clay, which is also referred to as the feed material. For example, a cross-coiler mill can be used for moister clay and a jaw crusher for drier clay. In these pre-crushing units 14, the clay is pre-crushed to a size in the range of 100 mm or smaller, preferably 50 mm or smaller.

The pre-comminuted clay is then fed to a pre-drying device 90. The pre-drying device 90 is located above the central unit of the clay calcination plant 10 according to the invention, a rotary kiln 20.

The pre-drying device 90 is used to utilize energy in the form of heat, which is radiated by the rotary kiln 10, in order to preheat the crushed feed material and to evaporate already any water that is on the surface. For this purpose, the pre-drying device 90 can be configured as an enclosed steel plate conveyor, for example. On the one hand, the steel plate conveyor is heated by directly radiated heat from the rotary kiln and passes this heat on to the pre-comminuted clay: on the other hand, warm air rising through the enclosure, convection, is caught by the rotary kiln, so that a warm atmosphere is present in the enclosure, which is also used to preheat the pre-comminuted clay.

The pretreated clay is then passed on to a dryer 80, which is located directly in front of the rotary kiln 20. The rotary kiln 20 is operated as a directly heated rotary kiln. This means that the material to be treated is fed into the rotary kiln 20 at a kiln inlet 21, is conveyed through the kiln by the kiln's rotation and inclination and then exits the rotary kiln 20 at a kiln outlet 22. In the opposite direction to this material flow, a process gas flows through the rotary kiln 20, which is used for calcination according to the invention and is therefore referred to below as calcination gas. This calcination gas flows in at a gas infeed 31 at the end of the rotary kiln 20, where the kiln outlet 22 is located. It flows through the rotary kiln 20 and exits it again at a gas outfeed 32, which is located on the side of the kiln inlet 21. The calcination gas leaving the rotary kiln 20 is passed through the dryer 80. The dryer 80 can be configured as a drum dryer, for example. The calcination gases used in dryer 80 leave said dryer at a temperature of approximately 400° C. The feed material is further preheated in the dryer 80 before being fed into the rotary kiln 20.

The calcination gas enters the rotary kiln 20 through the gas infeed 31. This takes place as a temperature-homogeneous calcination gas flow. This means that the inflowing calcination gas has a homogeneous temperature both over time and over the entire volume. This temperature depends on the clay to be calcined and is in the range of 600° C. to 900° C.

The contact of the preheated and pre-comminuted clay in the rotary kiln 20 with the calcination gas results in dewatering of both the surface water and the crystal water. The transformation into a material with pozzolanic properties, which can be described as metakaolin or metaclay, also takes place.

A mixing chamber 40 is arranged directly in front of the kiln outlet 22, which can also be referred to as the riser, of the rotary kiln 20, which serves to generate or premix the temperature-homogeneous flow of calcination gas that flows through the gas infeed 31 into the rotary kiln 20. In principle, however, the mixing chamber can also be arranged at a slight distance from the rotary kiln 20.

The mixing chamber 40 is shown in greater detail in a further sketch in FIG. 2. It can have an essentially cylindrical shape. A burner 42 is provided on a first face side 41, which has a combustion gas infeed 51 and a combustion air infeed 52. A lance with a burner nozzle 43 extends from the burner 42 into the space of the mixing chamber 40.

If the burner 42 is ignited, flue gas 46 heated by the burner 42 flows into the mixing chamber 40. Here, the burner lance 43 is preferably arranged axially on the central axis of rotation of the mixing chamber 40, so that the generated flue gas 46 also enters in the direction of the axis of rotation. Flue gas 46 can be referred to as gas that is produced during the combustion of combustion gas, such as natural gas, with combustion air.

In addition, the mixing chamber 40 has a process gas infeed 45 through which, as explained in more detail later, warm or hot process gas can flow into the mixing chamber 40. The process gas infeed 45 is configured in such a way that a spiral-like air flow 47 is preferably generated during the inflow, which wraps around the flue gas 46. This stimulates extremely good mixing, so that a temperature-homogeneous gas flow, preferably with a temperature of between 750° C. and 1000° C., is present at the outlet 54 of the mixing chamber 40. This gas flow is then injected directly into the rotary kiln 20.

To further improve mixing, baffle plates 48 and/or deflecting plates can be provided both in the process gas infeed 45 and alternatively or additionally directly in the mixing chamber 40, in particular to provide the incoming process gas with a swirl or turbulences and thus promote intensive mixing. It is also possible to alternatively or additionally provide a post-mixing disk 49 at the outlet 54 of the mixing chamber 40.

The origin of the process gas used will be discussed in more detail below. The material flow of the calcined clay from the rotary kiln 20 is now further followed. Said flow exits the rotary kiln 20 at a temperature of between 650° C. and 850° C., depending on the type of calcined clay and its composition. The calcined clay is fed to a cooler 110 for cooling, which is preferably a grate cooler. Cooling air flows through this cooler and cools the calcined clay to below 400° C. in a period of less than 20 minutes, preferably less than 10 minutes. On the one hand, this serves to prepare the calcined clay for further processing at an optimum temperature. In this context, it can also be cooled further to approx. 100° C. On the other hand, this prevents a reversal of the iron reduction, which is described in detail later in relation to the regulation. This requires rapid cooling of the calcined clay.

After the cooler 110, the cooled calcined clay can be fed directly to a comminution unit in the form of, for example, a vertical roller mill 120, in particular according to the Loesche principle. However, it is also possible to temporarily store the cooled calcined clay in a bunker 113. Several different bunkers 114, 115 can also be provided. For example, it is possible to provide clinker in bunker 114 and gypsum in bunker 115, which are mixed via a conveyor belt 116 and can accordingly be fed to the mill 120.

In the mill 120, the calcined clay is crushed with the other optional materials. Comminution to about R60 μm <15% is preferred here. With the process gas of the mill 120, which is used to operate the mill in recirculation mode, the calcined and comminuted clay with the other facultative materials is transported to a filter 125, in which it is separated from the process gas transporting it. This filter 125 can be configured as a bag filter, for example. The material prepared in this way, which can now be referred to as cement substitute or cement additive, is fed to the cement production process via the filter 125.

With regard to bunker or silo 114, it was mentioned that gypsum may be present therein. If gypsum is used, it is necessary that this gypsum is also dewatered. The mill 120 is often operated in a temperature range around 95° C. Experience has shown that this is not sufficient to dewater gypsum. Therefore, according to the clay calcination plant 10 according to the invention, it may can be provided that the gypsum is also fed from the bunker 115 into the cooler 110. In this case, feeding takes place at a suitable point at which the calcined clay still has a sufficiently high temperature of approximately 150° C. to 180° C. to also dewater the gypsum.

The air and gas flows in the clay calcination plant 10 according to the invention will now be described in greater detail. The following description begins in the rotary kiln 20. The calcination gas, which has flowed into the rotary kiln 20 through the gas infeed 31 at a temperature in the range between 600° C. and 900° C., flows through the rotary kiln 20 in the opposite direction to the material flow of the clay to be calcined and releases its heat to the clay to be calcined and the rotary kiln 20. At the gas outfeed 32, the calcination gas now has a temperature in the range between 500° C. and 700° C. After it has additionally released heat in the dryer 80, the cooled calcination gas is passed on to a first dedusting device 130. This may be a cyclone, for example. Approx. 95% of the dust is separated there. The dust is produced in the rotary kiln 20 by the thermal comminution and calcination of the clay, as moisture is expelled at lower temperatures and crystal water is expelled at higher temperatures, causing the clay to swell. Even the smallest clay particles are entrained in the countercurrent of the calcination gas flow.

The clay separated by the first dedusting device 130 has already been subjected to a certain temperature, as it has already passed through steps of the calcination process in the rotary kiln 20. However, it is not ensured that the clay dust is also completely calcined. For this reason, the clay dust separated in the first dedusting device 130 is fed via a first dedusting line 131 to the material flow directly after the rotary kiln 20, ideally in the area of the rotary kiln outlet 22. Here, the clay from the rotary kiln 20 has a temperature in the range of 800° C., so that the small particle size of the dust ensures that it is also calcined if it has not yet been calcined.

The dedusted calcination gas from the dedusting device 130 is fed to a process gas generator 60. In the process gas generator 60, the cooled calcination gas is heated to a temperature of about 750° C. by means of a provided process gas burner 61 together with the flue gases generated by the process gas burner 61. Appropriate combustion gas and a combustion air infeed are used for this purpose. This heating partially removes pollutants already present in the cooled calcination gas. In particular, environmentally harmful hydrocarbon compounds are destroyed.

The process gas heated in the process gas generator 60 is then fed via a mixing chamber pipe 65 to the mixing chamber 40 via the process gas infeed 65. When it enters the mixing chamber 40, the now warm process gas has a temperature of approx. 650° C.

An afterburner branch 75 is provided in the mixing chamber pipe 65. By means of this, a portion of the heated process gas is branched-off from the mixing chamber pipe 65 and fed to a thermal afterburning device 70. Here, approximately 60% of the heated process gas is guided to the mixing chamber 40 and the remaining approximately 40% to the thermal afterburning device 70.

The thermal afterburning device 70 also comprises a burner, in this case an afterburner 71, which in turn is operated with combustion air and a correspondingly combustible gas. In this burner, the branched-off process gas is heated to a temperature of at least 850° C. by means of the heat and flue gas generated by the afterburner 71 and held for at least 2 seconds. This further second heating serves to destroy any pollutants in the process gas that have not yet been destroyed.

Subsequently, the process gas thus purified by the thermal afterburning device 70 is fed to a heat exchanger 150. This serves to utilize the thermal energy of the gas originating from the afterburning device 70 to preheat combustion air of at least one, preferably all three burners provided in the clay calcination plant 10 according to the invention, in order to reduce their energy consumption. The burners are the burner 42 in the mixing chamber, the process gas burner 61 of the process gas generator and the afterburner 71 of the thermal afterburning device 70.

The heat exchanger 150 can be used to heat the combustion air to a temperature of approximately 400° C. At this point, the formerly hot gases from the thermal afterburning device 70 have a temperature of approximately 350° C. after exiting the heat exchanger 150.

In order to utilize this energy further, the gas is passed on to a power generator 161, in which the thermal energy is converted into electricity. The gas now present, which is referred to below as process gas, is passed on to the mill 120 at a temperature slightly above 100° C.

The air that is used as cooling air to operate the cooler 110 is also heated to approx. 400° C. by the calcined clay, as heat transfer takes place here. In addition, the air is also contaminated with dust due to the dust-loaded clay. For this reason, a second dedusting device 140 is provided, which can also be configured as a cyclone. The heated cooling air from the cooler 110 is fed to the second dedusting device 140 and dedusted there. The recovered dust is fed directly to the material flow of the calcined clay downstream of the cooler 110 by means of a second dedusting line 141. The substantially dedusted air, which in each case has a significantly higher temperature than the environment, can then also be fed to a power generator 162, in order to generate electric power from the thermal energy, which can be used for the clay calcination plant 10.

The cooling gas cooled by the power generation is now also passed on to the grinder 120. The cooling gas has a temperature in the range of slightly above 100° C. The process gas entering the mill 120 in this way has been largely dedusted by means of the first dedusting device 130 or respectively the second dedusting device 140. However, it still has very fine dust particles.

A water feed 121 can be provided to further cool the process gas flowing into the mill 120 if necessary.

In order to regulate the amount of process gas flowing into the mill 120, a bypass line around the mill to the filter 125 is additionally provided.

The calcined clay is crushed by means of the mill 120 and transported to the filter 125 with the blown-in process gas. In this filter, the process air is essentially completely dedusted so that the process air can be blown out downstream the filter 125 via a stack 127. As described above, this air either originates from the cooling air of the cooler 110 or has been treated by the thermal afterburning device 70 so that no longer environmentally harmful gases are present. Due to the described coupling of the individual process stages, in accordance with the intended conduit routing, there is only one point of residual dedusting of the process gases. Intermediate cleanings are therefore not necessary.

In the embodiment shown, a hot gas generator 123 is also provided, which is provided in a recirculation line of the dedusted air from the filter 125 and can additionally heat the process air for the mill 120. This is useful if the clay calcination plant 10 does not yet generate sufficiently warm process air or useful in order to use the mill 120 separately.

The central regulation and control device 100 is described in more detail below. In addition to a number of other regulation and control tasks, it essentially has two central tasks: Firstly, the regulating and control device 100 is responsible for ensuring that the calcination gas flow, which flows through the gas infeed 31 into the rotary kiln 20, has a desired temperature in the range between 600° C. and 900° C. This ensures that the feed material is heated to the desired temperature of between 650° C. and 850° C. On the other hand, the regulating and control device 100 serves to set the oxygen content of the calcination gas as it flows into the rotary kiln 20.

For adjusting the temperature, both the temperature of the burner 42 of the mixing chamber 40 and the amount of flue gas 46 produced can be adjusted via the regulating and control device 100. In addition, the amount of warm process gas supplied from the process gas generator 60 via the process gas infeed 45 can be adjusted via corresponding valves. The temperature of this process gas can in turn be varied via the burner temperature of the process gas burner 61. Overall, these regulation variables ensure that an optimum temperature for the calcination process of the clay is present at the outlet of the mixing chamber 40 or respectively at the gas infeed 31 of the rotary kiln 20.

Another task of the regulating and control device 100 is to adjust the oxygen content of the calcination gas flowing into the rotary kiln 20. During the calcination of the clay, a conversion of existing Fe₂O₃ to Fe₂O₄ and subsequently to FeO takes place in a reductive atmosphere. Fe₂O₃ leads to a red or respectively yellow coloration, which is undesirable in the building materials industry, so that Fe₃O₄ or respectively FeO should preferably be present in the calcined clay.

For this reason, the calcination gas should have a particularly low oxygen proportion. The oxygen proportion of the calcination gas is therefore set accordingly via the regulation and control device 100. To this end, the operating mode of the burner 42 of the mixing chamber 40 again serves as the setting parameter. Here, the oxygen content of the flue gas 46 can be influenced by the ratio of combustion gas and combustion air. Similarly, the oxygen content of the warm process gas, which comes from the process gas generator 60, can also be adjusted via the burner temperature of the process gas burner 61 and its proportions of combustion air. For this purpose, a secondary process gas infeed can also be provided in the process gas generator 60.

By means of the clay calcination plant according to the invention, it is possible to calcine clay in very good quality using a rotary kiln. In addition, the overall design of the plant describes an energy-efficient process, wherein individual parts and individual steps can also be used separately and not all of the individual elements described are always required. It is therefore not absolutely necessary to use obligatory all the individual components of the system in combination; for example, the power generators or the heat exchanger can be dispensed with. The thermal afterburning device is also not always necessary, depending on the country-specific environmental regulations, for example.

1. Clay calcination plant (10) for the activation of clay as a feed material, which clay has a significant proportion of at least 40% of thermally activatable layered silicates in the form of kaolinite, illite and/or montmorillonite,
comprising a directly heated rotary kiln (20), which comprises a kiln inlet (21) and a kiln outlet (22), wherein the rotary kiln (20) is configured to convey the feed material as a material flow from the kiln inlet (21) to the kiln outlet (22) and to thermally treat it while conveying it,
wherein a gas infeed (31) is provided at the kiln outlet (22) and a gas outfeed (32) is provided at the kiln inlet (21), and
wherein the clay calcination plant is configured to guide calcination gas from the gas infeed (31) through the rotary kiln (20) to the gas outfeed (32), characterized
in that the gas infeed (31) of the rotary kiln (20) is fluidically connected to a mixing chamber (40) for generating a temperature-homogeneous flow of calcination gas,
in that the mixing chamber (40) has a cylindrical-like shape,
in that a burner (42) for generating hot flue gas (46) from combustion gas as an energy source and combustion air is provided on a face side (41) of the mixing chamber (40),
in that the mixing chamber (40) has a process gas infeed (45) for the infeed of warm process gas,
in that the clay calcination plant is configured to supply warm process gas through the process gas infeed (45) into the mixing chamber (40),
in that the process gas infeed (45), the burner (42) and the mixing chamber (40) are configured to generate a spiral-like flow (47) of the warm process gas, at least in the region of the process gas infeed (45), in order to generate the hot flue gas (46) flowing axially into the mixing chamber (40) by means of the burner, in order to generate the temperature-homogeneous flow of calcination gas.

2. Clay calcination plant (10) according to claim 1, characterized
in that a process gas generator (60) is provided, which is configured to heat calcination gas from the gas outfeed (32) by means of a process gas burner (61), and
in that a mixing chamber pipe (65) is provided for feeding the heated process gas as warm process gas to the process gas infeed (45) into the mixing chamber (40).

3. Clay calcination plant (10) according to claim 2, characterized
in that a thermal afterburning device (70) with a thermal afterburner (71) is provided,
in that an afterburning branch (75) is provided in the mixing chamber pipe (65), in order to branch off a portion of the warm process gas from the mixing chamber pipe (65) and feed it to the thermal afterburning device (70), in that the thermal afterburning device (70) is configured to heat the supplied warm process gas by means of the thermal afterburner (71) in such a way as to burn off environmentally harmful substances in the resulting flue gas (46).

4. Clay calcination plant (10) according to one of the claims 1 to 3, characterized
in that a dryer (80) is arranged upstream of the kiln inlet (21) of the rotary kiln (20) in such a way
that feed material to be fed into the rotary kiln (20) via the kiln inlet (21) is transported through the dryer (80) and
that calcination gas from the gas outfeed (32) is guided through the dryer (80).

5. Clay calcination plant (10) according to one of claims 1 to 4, characterized
in that spatially above the rotary kiln (20) a pre-drying device (90) for the feed material is arranged, which is configured and set up to pre-dry the feed material by means of radiant heat radiated from the rotary kiln and/or free convection of the rotary kiln (20) and to supply it to the rotary kiln (20) and/or the dryer (80).

6. Clay calcination plant (10) according to one of claims 1 to 5, characterized
in that a control and regulation device (100) is provided which adjusts the temperature of the calcination gas at the gas infeed (31) for activating the feed material at least by means of the burner (42) in the mixing chamber (40) and the quantity and/or the temperature of the warm process gas.

7. Clay calcination plant (10) according to one of the claims 1 to 6, characterized
in that a control and regulation device (100) is provided which, at least by means of the burner (42) in the mixing chamber (40) and the quantity and/or the oxygen content of the warm process gas, adjusts the oxygen content of the calcination gas at the gas infeed (31), in order to influence the color of the activated feed material.

8. Clay calcination plant (10) according to one of the claims 1 to 7, characterized
in that a cooler (110), in particular a grate cooler, is provided downstream of a material flow of activated feed material after the kiln outlet (22) of the rotary kiln (20), which cooler is configured to cool the feed material activated by thermal treatment to below 400° C. by means of cooling air within 10 minutes to 20 minutes.

9. Clay calcination plant (10) according to claim 8, characterized
in that a comminution device (120), in particular a vertical roller mill, is provided downstream of the material flow after the cooler (110), which is configured to comminute the cooled, activated feed material to a maximum size of R60 μm<15%.

10. Clay calcination plant (10) according to one of the claims 1 to 9, characterized
in that a first dedusting device (130) is provided, which is set up and connected for dedusting calcination gas from the dryer (80) and/or the rotary kiln (20) and
in that a first return line (131) is provided, in order to supply the dust separated in the first dedusting device (130) from the calcination gas to a material flow of activated feed material upstream of the cooler (110).

11. Clay calcination plant (10) according to one of the claims 8 to 10, characterized
in that a second dedusting device (140) is provided, which is set up and connected for dedusting cooling air from the cooler (110), and
in that a second return line (141) is provided, in order to supply the dust separated in the second dedusting device (130) from the cooling air to a material flow of cooled, activated feed material downstream of the cooler (110).

12. Clay calcination plant (10) according to one of the claims 4 to 11, characterized
in that a heat exchanger (150) is provided and connected, which is set up to preheat combustion air for the process gas burner (61), combustion air for the thermal afterburner (71) and/or combustion air for the burner (42) of the mixing chamber (40) by means of heat from the flue gas (46) of the thermal afterburning device (70).

13. Clay calcination plant (10) according to one of the claims 4 to 12, characterized
in that at least one power generator (161, 162) is provided and connected, which generates power by means of the cooling air from the cooler (110) and/or by means of the flue gas from the thermal afterburning device (70).

14. Clay calcination plant (10) according to one of the claims 9 to 13, characterized
in that a conduit routing is provided, in order to use flue gas (46) from the thermal afterburning device (70) and/or cooling air from the cooler (110) as process gas for the comminution device (120).

15. Clay calcination plant (10) according to one of the claims 10 to 14, characterized
in that a conduit routing is provided for supplying calcination gas, at least partially cleaned of dust, from the first dedusting device (130) to the process gas generator (60) and/or for supplying the cooling air, at least partially cleaned of dust, from the second dedusting device (140) to the comminution device (120) as process gas.
